(19) United States
(12) Patent Application Publication
(10) Pub. No.: US 2006/0031808 A1
(43) Pub. Date: Feb. 9, 2006

(54) System and method for creating timing constraint information

(75) Inventor: Toru Toyoda, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/185,009

(22) Filed: Jul. 20, 2005

(30) Foreign Application Priority Data
Jul. 22, 2004 (JP) 2004/214074

(51) Int. Cl. G06F 17/50

(52) U.S. Cl. 716/18; 716/6

(57) ABSTRACT

A method of creating a timing constraint information which provides a timing constraint value of a cell, includes: (a) a processor setting a predetermined range including the timing constraint value as a scope; (b) the processor executing a simulation by using a preliminary timing constraint value within the scope to verify whether the cell operates normally or not; and (c) the processor determining the timing constraint value by repeating the step (b) based on a binary search method. In the step (b), the processor sets a precision of the simulation such that the precision becomes higher as a size of scope becomes smaller.

### BACKGROUND OF THE INVENTION

1. Field of the Invention

The present invention relates to a technique of LSI designing. In particular, the present invention relates to a system and a method for creating a timing constraint information which provides a timing constraint values of a cell.

2. Description of the Related Art

In a process of designing an LSI, to utilize a computer and a CAD (Computer Aided Design) is indispensable in order to reduce designing time and checking time and to avoid artificial mistakes. In the field of the LSI designing, a technique of utilizing a “cell”, which is a functional block having a specific function, for the purpose of further improving development efficiency is publicly known. According to a cell-base design which utilizes the cell, a desired LSI is designed by combining and arranging a plurality kinds of cells. As a result, the designing time is shortened and productivity is improved.

An information which indicates timing constraints for a normal operation of such a cell is called a “timing constraint information (timing constraint value)”. In a case of a sequential circuit, the timing constraint information includes, for example, a “setup time” and a “hold time” of a data signal with respect to a clock signal. Such the timing constraint information is distributed together with circuit information of the designed/verified cell. A conventional technique whose purpose is to calculate the setup time efficiently by a simulation with a desired precision is disclosed in Japanese Laid Open Patent Application JP-H10-21292.

After an LSI is designed on the basis of the cell-base design, a “timing analysis” is performed in which an operation of the designed LSI is analyzed and verified. In order to carry out the timing analysis for an LSI including a plurality of cells, it is necessary to obtain information about interconnections between the plurality of cells and the above-mentioned timing constraint information with respect to each of the plurality of cells. For that purpose, a “timing constraint library” which provides the timing constraint information of respective cells is prepared, and then the above-mentioned timing analysis is performed by referring to the timing constraint library.

The information amount of the timing constraint library is vast, and it is preferable to reduce the time required for creating the timing constraint library. Therefore, it is strongly desired to decide the timing constraint information for each cell more efficiently.

### SUMMARY OF THE INVENTION

In an aspect of the present invention, a method of creating a timing constraint information (timing constraint library) which provides a timing constraint value of a cell is provided. The method includes: (A) a processor setting a predetermined initial range including the timing constraint value as a scope; (B) the processor selecting n (n is an integer not less than 3) preliminary timing constraint values from the scope; (C) the processor executing a simulation by using each of the n preliminary timing constraint values to verify whether the target cell operates normally or not; (D) the processor extracting two preliminary timing constraint values from the n preliminary timing constraint values based on a result of the simulation, wherein the two preliminary timing constraint values are two closest values to a boundary between an normal operation and an abnormal operation of the cell; (E) the processor setting a range defined by the two preliminary timing constraint values as the scope; and (F) the processor determining the timing constraint value by repeating the step (B) to the step (E) until a size of the scope becomes equal to or lower than a predetermined criterion. In this manner, whereabouts of the timing constraint value (solution) is retrieved from the initial range. The processor stores the determined timing constraint value in a memory device as the timing constraint information.

In the above-mentioned step (C), the processor sets a precision of the simulation based on the size of scope. For example, the processor may determine the precision of simulation by referring to a precision decision table which is stored in the memory device and indicates a relation between the size of scope and the precision of simulation. Here, the precision of simulation is defined by a group of parameters such as a time step in a transient analysis, a criterion of convergence on the numerical calculation, a selected algorithm and so on. The processor preferably sets the precision of simulation such that the precision of simulation becomes higher as the size of scope becomes smaller. In this case, calculation load in an initial stage of the simulation is reduced, and thus the time required for the simulation is shortened. That is to say, the time for creating the timing constraint library is reduced. Moreover, as the whereabouts of the solution come to be narrowed down, the precision of simulation is set to be higher. Therefore, precision of the solution obtained as a result is ensured. In other words, precision of the created timing constraint library is ensured.

In another aspect of the present invention, a system for creating a timing constraint information which provides a timing constraint value of a cell is provided. The system has a library creating module, and a simulation module configured to carry out a simulation to verify whether the target cell operates normally or not under a predetermined condition. The library creating module is realized by a processor and a library creating software executed by the processor, and the simulation module is realized by the processor and a simulation software executed by the processor. The library creating module sets a predetermined initial range including the timing constraint value as a scope. Also, the library creating module carries out a first operation of selecting n (n is an integer not less than 3) preliminary timing constraint values from the scope and deciding a precision of the simulation based on a size of the scope. The simulation module carries out the simulation by using each of the n preliminary timing constraint values based on the decided precision. The library creating module carries out a second operation of extracting two preliminary timing constraint values closest to a boundary between an normal operation and an abnormal operation of the cell from the n preliminary timing constraint values based on a result of the simulation, and setting a range defined by the two preliminary timing constraint values as the scope. The library creating module and the simulation module carry out respective of the first operation, the second operation and the simulation repeatedly. Then, the library creating module determines the timing constraint value based on the scope when the size of scope becomes equal to or lower than a predetermined criterion, and stores the determined timing constraint value in a memory device as the timing constraint information.

According to the method and the system for creating the timing constraint information of the present invention, the time required for creating the timing constraint information can be reduced. Moreover, the precision of the created timing constraint information can be ensured.

### BRIEF DESCRIPTION OF THE DRAWINGS

The above and other objects, advantages and features of the present invention will be more apparent from the following description taken in conjunction with the accompanying drawings, in which:

FIG. 1 is a block diagram schematically showing a configuration of a timing constraint library according to an embodiment of the present invention;

FIG. 2 is a block diagram schematically showing a configuration of a constraint table group according to the embodiment of the present invention;

FIG. 3 is a schematic diagram for explaining a timing constraint value according to the embodiment of the present invention;

FIG. 4 is a schematic diagram for explaining a timing constraint table according to the embodiment of the present invention;

FIG. 5 is a conceptual diagram showing a method of creating the timing constraint library according to a first embodiment of the present invention;

FIG. 6 is a conceptual diagram showing a method of creating the timing constraint library according to the first embodiment of the present invention;

FIG. 7 is a schematic diagram showing a precision decision table according to the first embodiment of the present invention;

FIG. 8 is a block diagram showing a configuration of a timing constraint library creating system according to the first embodiment of the present invention;

FIG. 9 is a block diagram showing an operation of the timing constraint library creating system according to the first embodiment of the present invention;

FIG. 10 is a flow chart showing the method of creating the timing constraint library according to the first embodiment of the present invention;

FIG. 11 is a conceptual diagram showing a method of creating the timing constraint library according to a second embodiment of the present invention;

FIG. 12 is a flow chart showing the method of creating the timing constraint library according to the second embodiment of the present invention; and

FIG. 13 is a conceptual diagram showing a method of creating the timing constraint library according to a third embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

First, concepts and terms used in this specification will be explained.

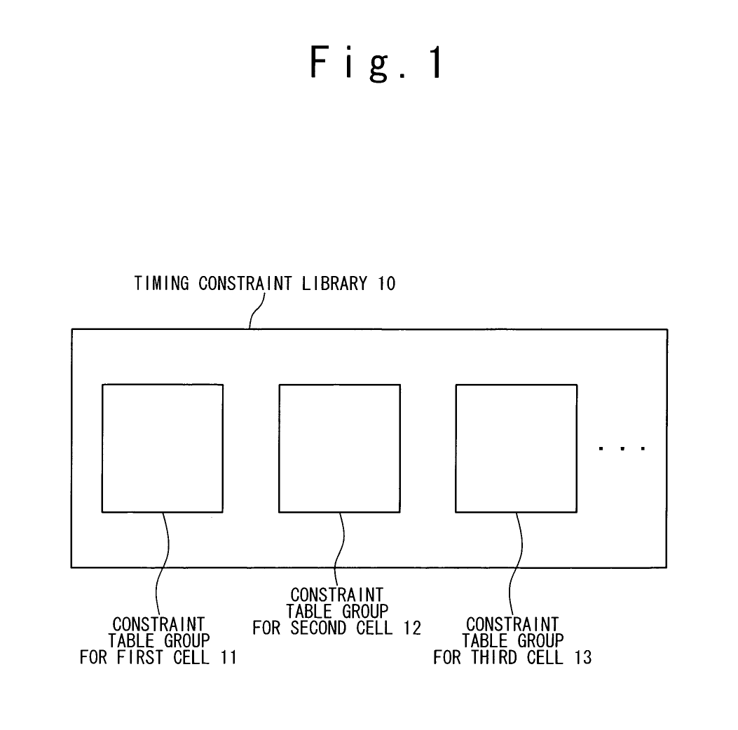

FIG. 1 is a block diagram schematically showing a configuration of a “timing constraint library” which is a target to be created in the present invention. The timing constraint library 10 provides “timing constraint information (timing constraint values)” with respect to a plurality kinds of cells. More specifically, the timing constraint library 10 includes a plurality of constraint table groups such as a constraint table group 11 for a first cell, a constraint table group 12 for a second cell, a constraint table group 13 for a third cell and the like. Each constraint table group provides timing constraint values with regard to the corresponding cell. The timing constraint values of each cell thus provided by the timing constraint library 10 are used in a timing analysis of an LSI.

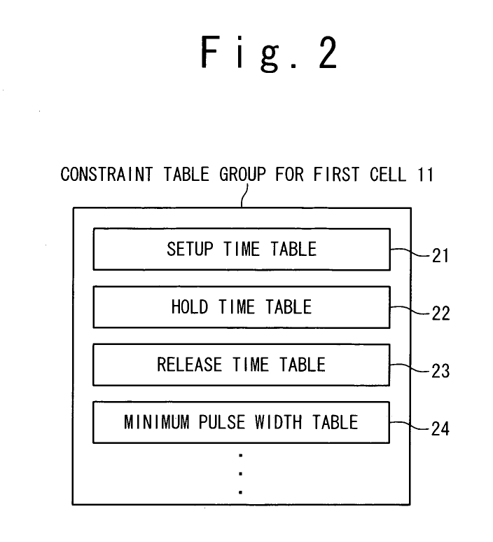

FIG. 2 is a block diagram schematically showing a configuration of one constraint table group shown in FIG. 1. As an example, a configuration of the constraint table group 11 for the first cell is shown. As shown in FIG. 2, the constraint table group 11 for the first cell includes a setup time table 21, a hold time table 22, a release time table 23, a minimum pulse width table 24 and the like.

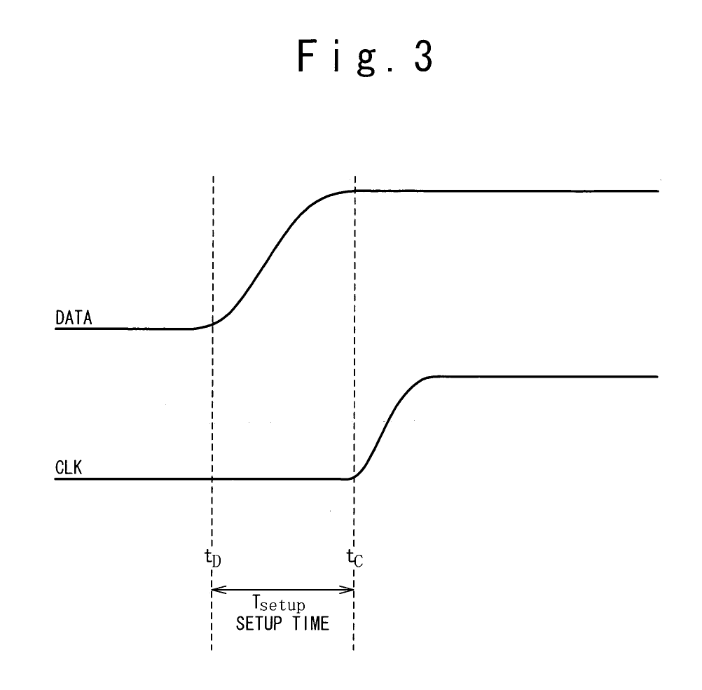

The setup time table 21 indicates a “setup time” defined for the first cell. FIG. 3 is a schematic diagram for explaining the setup time. The first cell is a sequential circuit such as a flip flop, and a data signal DATA and a clock signal CLK are input to the first cell. As shown in FIG. 3, the data signal DATA is input at the time t_{D}, and the clock signal CLK is input at the time t_{C} a predetermined delay time after the time t_{D}. A limit value (minimum value) of the delay time with which a latch operation is normally carried out is defined as the “setup time Tₛₑₜᵤₚ”.

Similarly, the hold time table 22 indicates a “hold time” defined for the first cell. In order to operate the cell normally, it is necessary to hold the data signal DATA for more than a certain period after the time t_{D} at which the clock signal CLK is input. The “hold time” indicates the minimum value of the holding period. Also, the release time table 23 indicates a “release time” defined for the first cell. The “release time” indicates a setup time of a reset signal with respect to the clock signal. Also, the minimum pulse width table 24 indicates a “minimum pulse width” defined for the first cell. The “minimum pulse width” indicates the minimum value of a pulse width required for the normal operation of the cell.

As mentioned above, the “timing constraint values” include the setup time, the hold time, the release time, the minimum pulse width and the like.

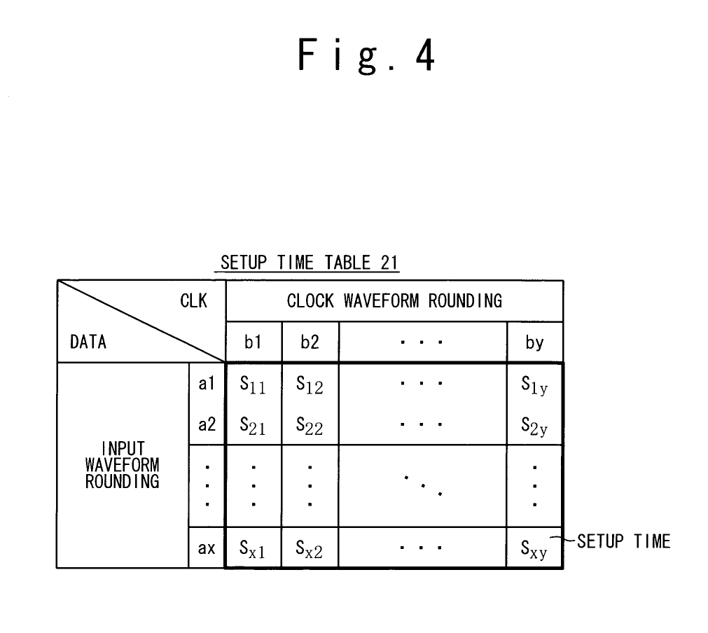

FIG. 4 shows the setup time table 21 in FIG. 2 in detail. As shown in FIG. 4, the setup time Sᵢⱼ is expressed as a function of two conditions (two table indices). The first condition is an “input waveform rounding (input slope)”, which indicates a waveform rounding of the input data signal DATA (see FIG. 3). The second condition is a “clock waveform rounding”, which indicates a waveform rounding of the input clock signal CLK (see FIG. 3). The setup time table 21 indicates (x×y) kinds of setup time S_{xy} corresponding to x kinds (x is a natural number) of the input waveform rounding a1 to ax and y kinds (y is a natural number) of the clock waveform rounding b1 to by. For example, when the input waveform rounding is a2 and the clock waveform rounding is b1, a “setup time S₂₁” can be obtained by referring to the present setup timetable 21. The same applies to configurations of other tables shown in FIG. 2.

According to the present invention, as will be described below in detail, a method and a system for creating such a timing constraint library 10 are provided. In order to produce the timing constraint library 10, it is necessary to create the constraint table groups (11, 12, 13) for respective cells (see FIG. 1). In order to create each constraint table group, it is necessary to create the timing constraint tables (21, 22, 23, 24) which indicate respective of the plurality kinds of timing constraint values (see FIG. 2). In order to create each timing constraint table, it is necessary to calculate the timing constraint values (Sᵢⱼ) for respective of the plurality of conditions (see FIG. 4). Hereinafter, creating the setup time table 21 shown in FIG. 4 will be described as a typical case. The same applies to cases when creating the other timing constraint tables.

### First Embodiment

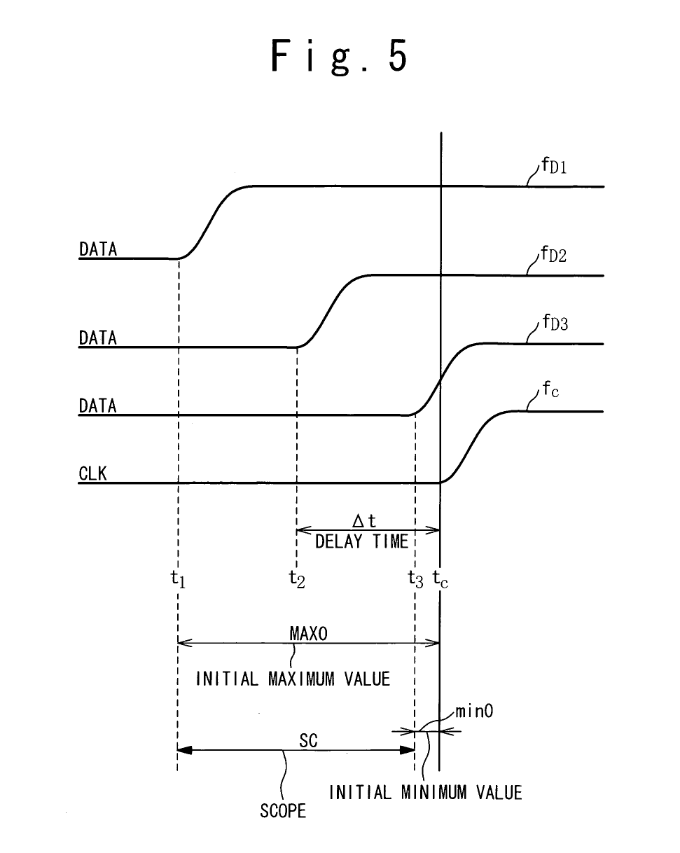

FIG. 5 is a conceptual diagram showing a method of obtaining a setup time, namely, a method of creating the timing constraint library 10. In FIG. 5, a waveform of a clock signal CLK is denoted by f_{C}, and the input time of the clock signal CLK is denoted by t_{C}. Also, three patterns of data signals DATA are shown in FIG. 5. Waveforms of respective data signals DATA are denoted by f_{D1}, f_{D2}, and f_{D3}, and input times of respective data signals DATA are denoted by t₁, t₂, and t₃. The delay time between the data signal DATA and the clock signal CLK is expressed as Δt.

As mentioned above, the setup time means a boundary value between a delay time with which a cell operates normally (hereinafter, referred to as a normal operation) and a delay time with which the cell does not operate normally (hereinafter, referred to as an abnormal operation). In order to find the boundary value, two values, an initial maximum value MAX0 and an initial minimum value min0, are first given as initial values: The initial maximum value MAX0 is a delay time with which the cell absolutely operates normally, and the initial minimum value min0 is a delay time with which the cell absolutely operates abnormally. In FIG. 5, a delay time Δt associated with the data signal DATA having the waveform f_{D1} is the initial maximum value MAX0, and a delay time Δt associated with the data signal DATA having the waveform f_{D3} is the initial minimum value min0. A range between the initial maximum value MAX0 and the initial minimum value min0 is referred to as a scope SC (an initial scope SC0). The size of the initial scope SC0 is given as: “SC0=MAX0−min0”.

The initial scope SC0 is searched for the above-mentioned boundary value (solution) by using a predetermined algorithm. As an algorithm for retrieving the solution efficiently, for example, a “binary search method” is used.

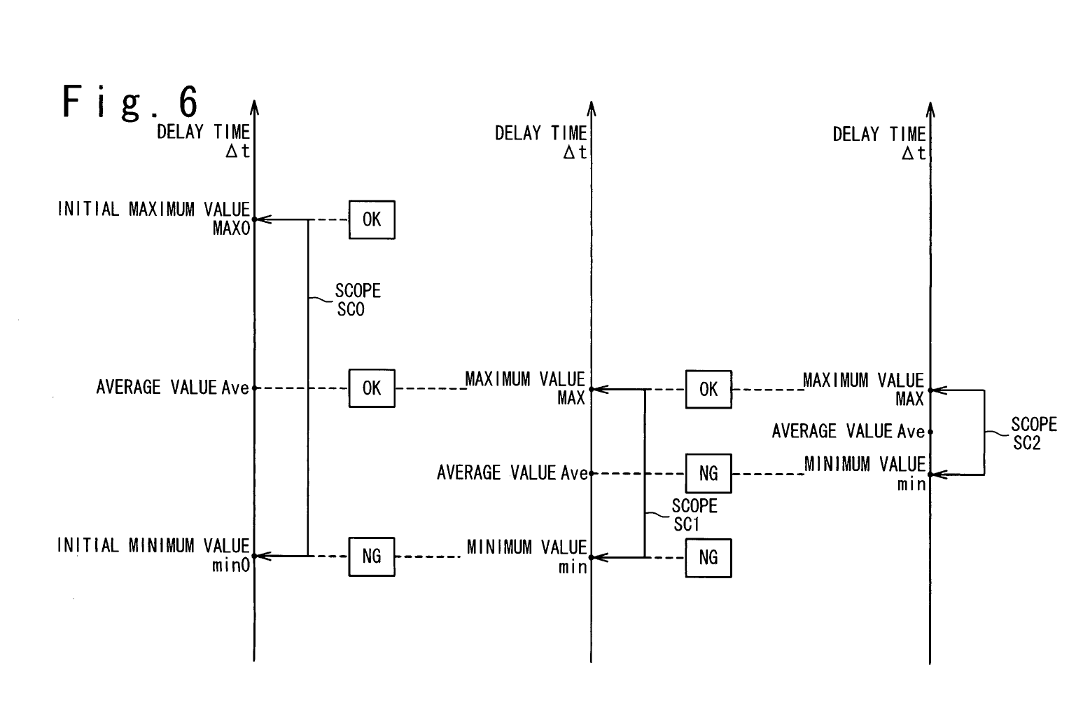

FIG. 6 is a conceptual diagram for explaining the method of searching for the solution (the setup time) by using the binary search method according to the present embodiment. A longitudinal axis of a graph in the figure indicates the delay time Δt. First, the initial maximum value MAX0 and the initial minimum value min0 mentioned above are set to appropriate values, and the initial scope (initial range) SC0 is determined as a range searched for the solution. The initial scope SC0 includes the setup time (timing constraint value) to be obtained.

Next, three “preliminary setup times (preliminary timing constraint values)” are selected from the initial scope SC0. The three preliminary setup times include the initial maximum value MAX0, the initial minimum value min0 and an average value Ave of the initial maximum value MAX0 and the initial minimum value min0. In other words, the initial scope SC0 is divided into two ranges equally by these three preliminary setup times MAX0, min0 and Ave.

Next, a simulation is executed by using each of the three preliminary setup times MAX0, min0 and Ave to verify whether the target cell operates normally or not. More specifically, three simulation data each of which indicates a signal pair (one data signal DATA and the clock signal CLK shown in FIG. 5) corresponding to each of the three preliminary setup times MAX0, min0, and Ave are prepared. For example, when the setup time S₂₁ of the setup time table 21 shown in FIG. 4 is searched for, three signal pairs are prepared: (1) the first signal pair consisting of a data signal DATA having the input waveform rounding a2 and a clock signal CLK having the clock waveform rounding b1, and corresponding to the preliminary setup time MAX0 (see waveforms f_{D1}, f_{c} in FIG. 5); (2) the second signal pair consisting of a data signal DATA having the input waveform rounding a2 and the clock signal CLK having the clock waveform rounding b1, and corresponding to the preliminary setup time Ave (see waveforms f_{D2}, f_{c} in FIG. 5); and (3) the third signal pair consisting of a data signal DATA having the input waveform rounding a2 and the clock signal CLK having the clock waveform rounding b1, and corresponding to the preliminary setup time min0 (see waveforms f_{D3}, f_{c} in FIG. 5). The three simulation data thus prepared are input to a predetermined circuit simulator such as a SPICE and the like to simulate whether the cell (test target circuit) operates normally or not.

It is found in the example shown in FIG. 6 that the cell operates normally (Pass: indicated by “OK” in the figure) as a result of the simulation based on each of the initial maximum value MAX0 and the average value Ave, while the cell does not operate normally (Fail: indicated by “NG” in the figure) as a result of the simulation based on the minimum value min0. In this case, it is obvious that the solution to be obtained, namely, the boundary between the normal operation (OK) and the abnormal operation (NG) of the cell lies between the average value Ave and the initial minimum value min0. Therefore, two preliminary setup times Ave and min0, which are closest to the solution to be obtained, are selected and extracted from the three preliminary setup times MAX0, min0 and Ave.

Next, a range defined by the extracted two preliminary setup times Ave and min0 is set as a new scope SC1. That is to say, the extracted preliminary setup time Ave is set as a maximum value MAX of the new scope SC1, and the extracted preliminary setup time min0 is set as a minimum value min of the new scope SC1. Here, a size of the new scope SC1 is given as: “SC1=MAX−min ”.

Next, the above-mentioned processing is repeated by using the new scope SC1. More specifically, three preliminary setup times are selected from the scope SC1. The three preliminary setup times include the maximum value MAX, the minimum value min and an average value Ave of the maximum value MAX and the minimum value min. Next, a simulation is similarly executed by using each of the three preliminary setup times MAX, min and Ave to verify whether the target cell operates normally or not. It is found in the example shown in FIG. 6 that the cell operates normally as a result of the simulation based on the maximum value MAX and the average value Ave, while the cell does not operate normally as a result of the simulation based on each of the average value Ave and the minimum value min0. In this case, it is obvious that the solution to be obtained, namely, the boundary between the normal operation (OK) and the abnormal operation (NG) of the cell lies between the maximum value MAX and the average value Ave. Therefore, two preliminary setup times MAX and Ave, which are closest to the solution to be obtained, are selected and extracted from the three preliminary setup times MAX, min and Ave.

Next, a range defined by the extracted two preliminary setup times MAX and Ave is set as a new scope SC2. Then, the above-mentioned processing is repeated by using the new scope SC2. According to the binary search method, as explained above, the size of the scope SC (MAX−min) becomes half every step. The above-mentioned operation is repeated until the size of the scope SC becomes equal to or lower than a predetermined criterion (grit number). When the size of the scope SC becomes equal to or less than the predetermined criterion, the “setup time” as the solution is determined on the basis of the scope SC. The determined setup time (the setup time S21 in the above example) is added to the setup time table 21 shown in FIG. 4.

According to the present embodiment, a precision of the simulation is not constant and is set based on the size of the scope SC (MAX−min) in the above-mentioned processing. Here, the precision of simulation depends on a group of parameters such as a time step in a transient analysis, a criterion of convergence on the numerical calculation, a selected algorithm and so on. The precision of the simulation can be changed by changing the group of parameters. For example, according to the present embodiment, the group of parameters is set such that the precision of simulation becomes higher as the size of the scope SC becomes smaller. As a result, computation is carried out with a rough precision in an initial stage, while with a finer precision as the processing approach the solution. As described above, the computation precision is not constant but variable according to the present invention.

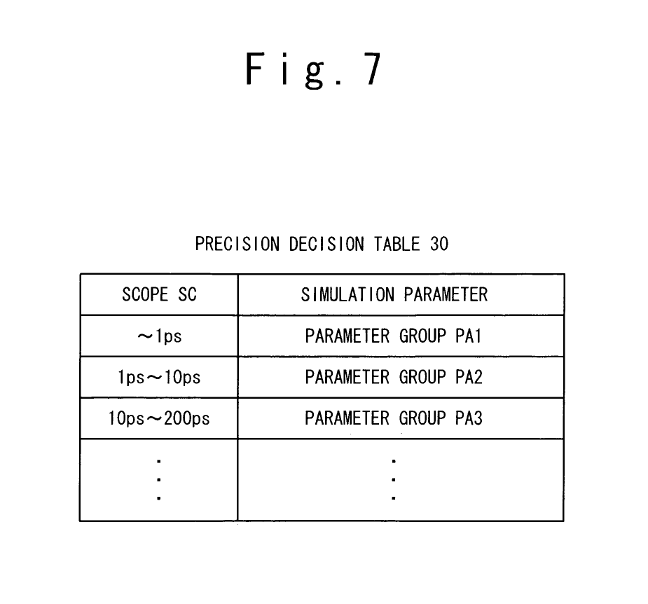

The setting of the simulation precision is performed, for example, by referring to a predetermined table. FIG. 7 is a schematic diagram showing a precision decision table 30 which is referred in the present embodiment. The precision decision table 30 indicates a relation between the size of the scope SC and the simulation precision. The simulation precision depends on a group of parameters such as a time step in a transient analysis, a criterion of convergence on the numerical calculation, a selected algorithm and so on. For instance, when the size of the scope SC is 1 ps or less, a parameter group PA1 is applied to the simulator. Similarly, when the size of the scope SC is greater than 1 ps and equal to or less than 10 ps, a parameter group PA2 is applied to the simulator. When the size of the scope SC is greater than 10 ps and equal to or less than 200 ps, a parameter group PA3 is applied to the simulator. In this case, the simulation precision specified by the parameter group PA1 is the highest, and the simulation precision specified by the parameter group becomes lower as the size of the scope becomes larger.

As described above, the simulation precision is not constant but variable according to the method of creating the timing constraint library 10 of the present invention. The computation is carried out with a rough precision in the initial stage of the simulation, while the computation is carried out with a finer precision as the processing approach the solution. As a result, calculation load in an initial stage of the simulation is reduced, and thus the time required for the simulation is shortened. That is to say, the time for creating the timing constraint library 10 is reduced. Moreover, as the whereabouts of the solution come to be narrowed down, the precision of simulation is set to be higher. Therefore, precision of the solution obtained as a result is ensured. In other words, precision of the created timing constraint library 10 is ensured.

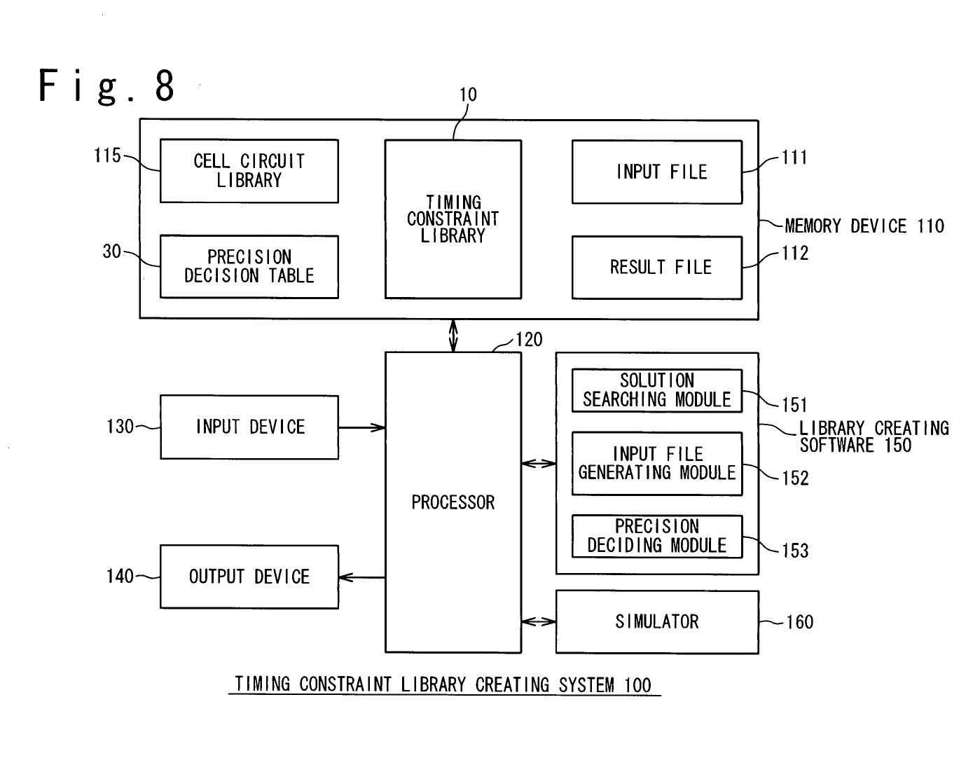

An example of a system for achieving the above-mentioned method of creating the timing constraint library 10 is shown in FIG. 8. FIG. 8 is a block diagram showing a configuration of a timing constraint library creating system 100. The timing constraint library creating system 100 according to the present embodiment includes a memory device 110, a processor 120, an input device 130, an output device 140, a library creating software 150, and a simulator 160. The timing constraint library creating system 100 is established on a work station, for example.

The processor 120 is connected with the above-mentioned devices, and controls an operation of the timing constraint library creating system 100 by performing various processing.

The library creating software 150 is a software program executed by the processor 120, and the library creating software 150 and the processor 120 serve as a “library creating module”. The library creating module carries out the above-mentioned searching for the solution (determination of the timing constraint value). The library creating module includes a solution searching module 151, an input file generating module 152, and a precision deciding module 153.

The simulator 160 is a simulation tool (simulation software) executed by the processor 120, and the simulator 160 and the processor 120 serve as a “simulation module”. The simulation module carries out the above-mentioned simulation. That is to say, the simulation module executes the simulation to verify whether the target cell operates normally or not under a predetermined condition.

The memory device 110 is connected to the processor 120, and stores the precision decision table 30 (see FIG. 7), an input file 111, a result file 112, and a cell circuit library 115. The input files 111 are files to be input to the simulator 160, and indicate the signal pairs (the data signal DATA and the clock signal CLK) corresponding to respective of the above-mentioned plurality of preliminary setup times (MAX, min, Ave). The result file 112 indicates a result of the simulation by the simulator 160, and indicates a signal output from an output pin of the cell. The cell circuit library 115 provides layout data of the cell. The layout data of the cell is referred to by the simulator 160 at the time of the simulation. Moreover, the timing constraint library 10 (see FIG. 1) produced by the timing constraint library creating system 100 is stored in the memory device 110. In addition, the above-mentioned library creating software 150 and the simulator 160 may be stored in the memory device 110.

The input device 130 is connected with the processor 120. The input device 130 includes a keyboard and a mouse. By using the input device 130, a user can give predetermined commands and data to the timing constraint library creating system 100. The commands and the data input from the input device 130 are processed by the processor 120. Also, an output device 140 is connected with the processor 120. The output device 130 includes a display and a speaker. The user can give a new instruction based on information output from the output device 140.

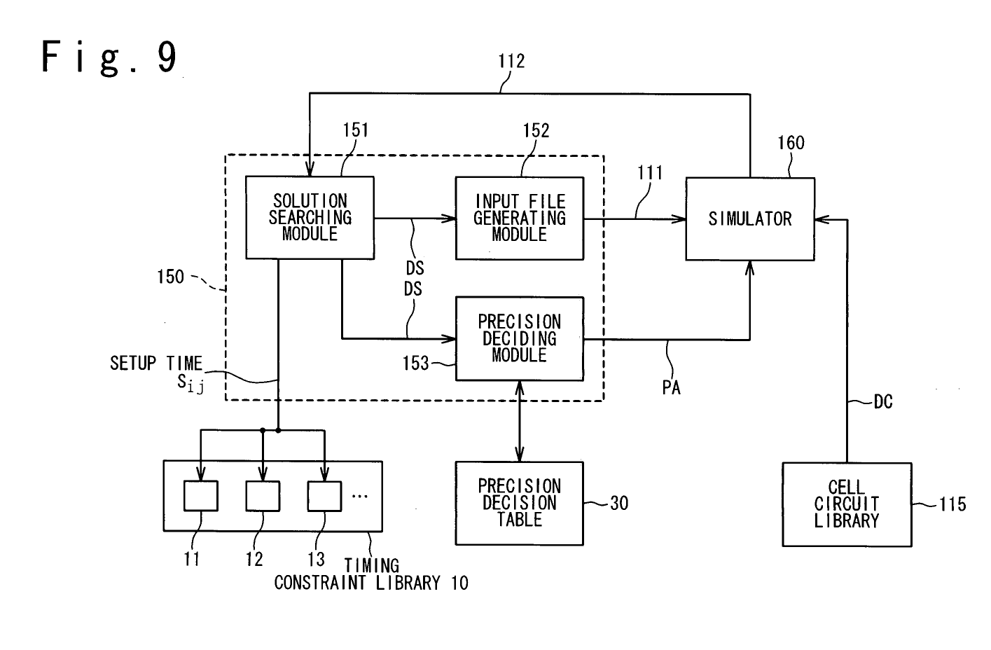

FIG. 9 is a block diagram showing an operation of the timing constraint library creating system 100. With reference to FIG. 9 and the foregoing FIG. 6, an operation of determining the setup time will be explained as an example. First, the solution searching module 151 decides the initial maximum value MAX0 and the initial minimum value min0, and sets the initial scope SC0 which is a range searched for the solution. The initial scope SC0 includes the setup time to be obtained (timing constraint value). Then, the solution searching module 151 outputs scope data DS indicative of the determined scope SC (the initial scope SC0) to the input file generating module 152 and the precision deciding module 153.

The input file generating module 152 receives the scope data DS, and selects three preliminary setup times from the set scope SC (the initial scope SC0). The three preliminary setup times include the initial maximum value MAX0, the initial minimum value min0, and the average value Ave of the initial maximum value MAX0 and the initial minimum value min0. Then, the input file generating module 152 generates three input files 111 which indicate the signal pairs (the data signal DATA and the clock signal CLK) corresponding to respective of the three preliminary setup times MAX0, min0 and Ave. The generated input files 111 are stored in the memory device 110.

The precision deciding module 153 receives the scope data DS, and decides the simulation precision on the basis of the size of the set scope SC (the initial scope SC0). More specifically, the precision deciding module 153 decides the simulation precision such that the simulation precision becomes higher as the size of the scope SC becomes smaller. Here, the precision deciding module 153 may possibly decide the simulation precision by using a predetermined function. Or, the precision deciding module 153 may decide the simulation precision by referring to the precision decision table 30 stored in the memory device 110. Then, the precision deciding module 15.3 outputs to the simulator 160 parameter group PA indicative of the decided simulation precision.

Next, the simulator 160 sets the simulation precision based on the parameter group PA output from the precision deciding module 153. Also, the simulator 160 reads out the input files 111 generated by the input file generating module 152 from the memory device 110. Further, the simulator 160 reads out cell circuit data DC indicative of a layout of the target cell from the cell circuit library 115 stored in the memory device 110. Then, the simulator 160 executes the simulation on the basis of the set simulation precision, the input files 111, and the cell circuit data DC. The result file 112 which indicates a result of the simulation is stored in the memory device 110.

Next, the solution searching module 151 reads out the result file 112 from the memory device 110. The present solution searching module 151 is programmed to execute the “binary search method”. That is, the solution searching module 151 extracts two preliminary setup times (Ave and min0) from the three preliminary setup times (MAX0, min0 and Ave) on the basis of the above-mentioned simulation result. The extracted two preliminary setup times are two closest values to the boundary value between the normal operation and the abnormal operation of the cell. Then, the solution searching module 151 sets the range defined by the two preliminary setup times (Ave and min0) as a new scope SC1. Then, the solution searching module 151 outputs scope data DS indicative of the new scope SC1 to the input file generating module 152 and the precision deciding module 153.

After that, similar operations are repeated by the library creating software 150 (library creating module) and the simulator 160 (simulation module). When the size of the scope SC becomes equal to or less than a predetermined criterion, the solution searching module 151 determines the “setup time” which is the solution, on the basis of the scope SC at that time. The solution searching module 151 adds the determined setup time Sᵢⱼ (i is an integer not less than 1 and not more than x; j is an integer not less than 1 and not more than y) to the setup time table 21 (see FIG. 4) stored in the memory device 110.

The same applies to a case when creating any of the hold time table 22, the release time table 23 and the minimum pulse width table 24 (see FIG. 2). The similar operations are repeated for each cell, and thus the timing constraint library 10 is created.

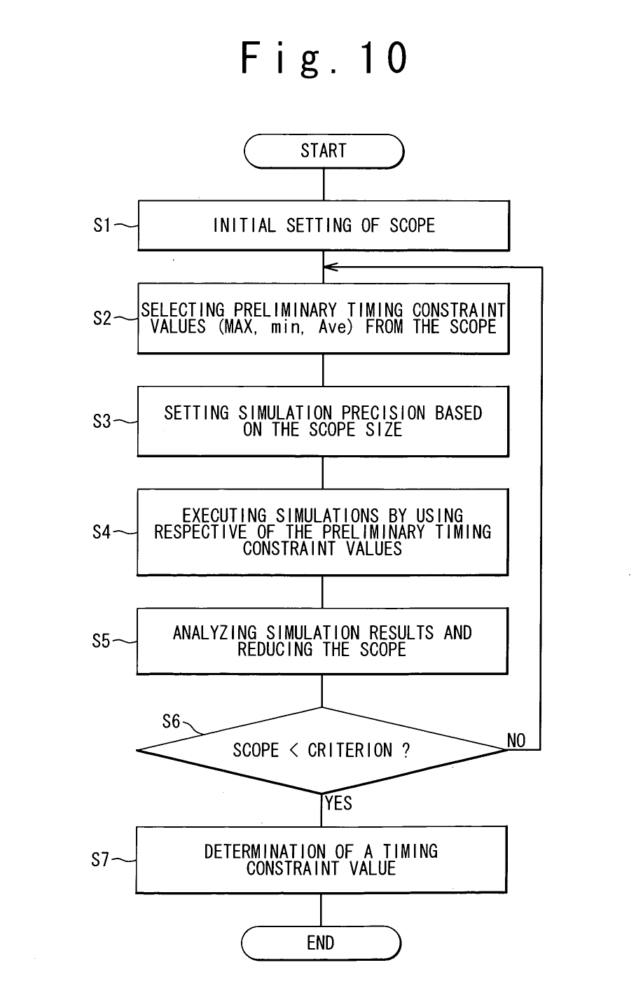

FIG. 10 is a flow chart which summarizes the method of creating the timing constraint library 10 according to the present embodiment. First, an initial setting of the scope SC is carried out by determining an initial maximum value MAX0 and an initial minimum value min0 (Step S1). Next, a plurality of “preliminary timing constraint values (ex. the preliminary setup times)” are selected from the set scope SC (Step S2). The plurality of the preliminary timing constraint values include, for example, the maximum value MAX of the scope SC, the minimum value min of the scope SC, and an average value Ave of the maximum value MAX and the minimum value min. Next, precision of simulation is set based on the size (MAX−min) of the set scope SC (Step S3). More specifically, the simulation precision is set to be higher as the size of the scope SC becomes smaller. Next, simulations are executed based on the set simulation precision by using respective of the plurality of the preliminary timing constraint values (Step S4). Next, the scope SC is reduced and a new scope SC is set based on an analysis of the simulation results (Step S5). When the size of the scope SC is larger than a predetermined criterion (Step S6; No), the above-mentioned steps S2 to S5 are repeated. When the size of the scope SC is equal to or smaller than the predetermined criterion (Step S6; Yes), the timing constraint value which is the conclusive solution is determined (Step S7).

As described above, according to the method and the system for creating the timing constraint library 10 of the present invention, the computation is carried out with a rough precision in the initial stage of the simulation, while the computation is carried out with a finer precision as the processing approach the solution. As a result, the calculation load in the initial stage of the simulation is reduced, and thus the time required for the simulation is shortened. That is to say, the time for creating the timing constraint library 10 is reduced. Moreover, as the whereabouts of the solution come to be narrowed down, the precision of simulation is set to be higher. Therefore, precision of the solution obtained as a result is ensured. In other words, precision of the created timing constraint library 10 is ensured.

### Second Embodiment

Each table shown in FIG. 2 indicates timing constraint values with respect to a plurality of conditions. For instance, as shown in FIG. 4, the setup time table 21 indicates setup times S_{xy} for respective combinations of input waveform rounding a1 to ax and clock waveform rounding b1 to by. Here, a timing constraint value (first timing constraint value) with respect to a certain condition (first condition) of the plurality of the conditions is considered to be only slightly different from a timing constraint value (second timing constraint value) with respect to a second condition close to the first condition. Therefore, when calculating the second timing constraint value, it is enough to set an initial scope SC0 in the vicinity of the known first timing constraint value as the range searched for the solution. In other words, it is sufficient to set an initial scope SC0 used for obtaining the second timing constraint value smaller than the initial scope SC0 used for obtaining the first timing constraint value. As a result, the time required for obtaining the second timing constraint value is reduced further.

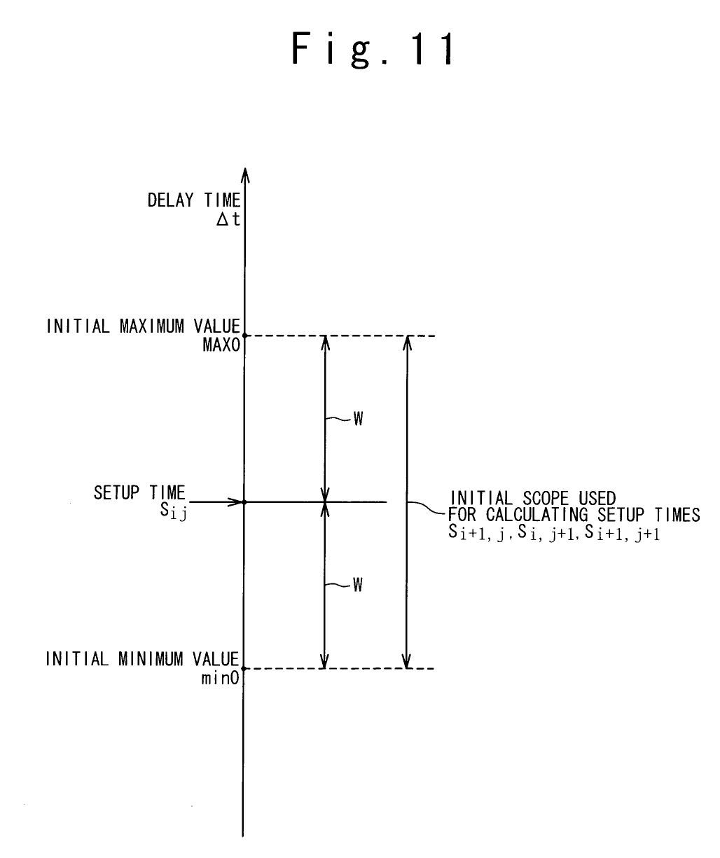

FIG. 11 is a conceptual diagram showing a method of creating the timing constraint library 10 according to a second embodiment of the present invention. A configuration of the timing constraint library creating system 100 in the second embodiment is the same as in the first embodiment shown in FIG. 8. First, the library creating module obtains the first timing constraint value associated with the first condition through the method described in the first embodiment.

Next, when calculating the second timing constraint value associated with the second condition which is different from the first condition, the library creating module reads out the already-known first timing constraint value from the timing constraint library 10. Then, the library creating module sets a predetermined range including the read first timing constraint value as a new initial scope SC0. Here, the new initial scope SC0 is smaller than the initial scope SC0 used for calculating the first timing constraint value. For example, the initial maximum value MAX0 of the new initial scope SC0 is set to a value which is larger by a predetermined value w than the already-known first timing constraint value, and the initial minimum value of min0 of the new initial scope SC0 is set to a value which is smaller by the predetermined value w than the already-known first timing constraint value. In other words, a center value of the new initial scope SC0 is the already-known first timing constraint value. The library creating module uses the new initial scope SC0 and calculates the second timing constraint value associated with the second condition by executing the operation described in the first embodiment. In particular, when the second condition is closest to the first condition, the time required for obtaining the second timing constraint value is preferably reduced.

A concrete example will be described below. As shown in FIG. 4, the setup time table 21 indicates the setup times Sᵢⱼ (i is an integer not less than 1 and not more than x; j is an integer not less than 1 and not more than y) corresponding to respective combinations of the input waveform rounding a1 to ax and the clock waveform rounding b1 to by. Here, it is assumed that values indicated by the input waveform rounding a1 to ax are sorted in ascending order or descending order, and values indicated by the clock waveform rounding b1 to by are also sorted in ascending order or descending order. In this case, two adjacent elements in the setup time table 21 indicate two setup times corresponding to two conditions close to each other.

It is preferable in the present example that the setup times S_{i+1, j}, S_{i, j+1} and S_{i+1, j+1} are calculated on the basis of the setup time Sᵢⱼ. For instance, a setup time S₁₁ corresponding to a combination of the input waveform rounding a1 and the clock waveform rounding b1 is first calculated. Next, setup times S₁₂, S₂₁ and S₂₂ are calculated on the basis of the obtained setup time S₁₁. Next, setup times S₁₃ and S₃₁ are calculated on the basis of the obtained setup times S₁₂ and S₂₁, respectively. Further, setup times S₂₃, S₃₂ and S₃₃ are calculated on the basis of the obtained setup time S₂₂. Such a calculating process is repeated, and setup times Sₓ₁ to S_{x(y-1)}, S_{1y} to S_{(x-1)y} and S_{xy} are obtained at the last. In this manner, all elements of the setup time table 21 are efficiently determined in a small amount of time.

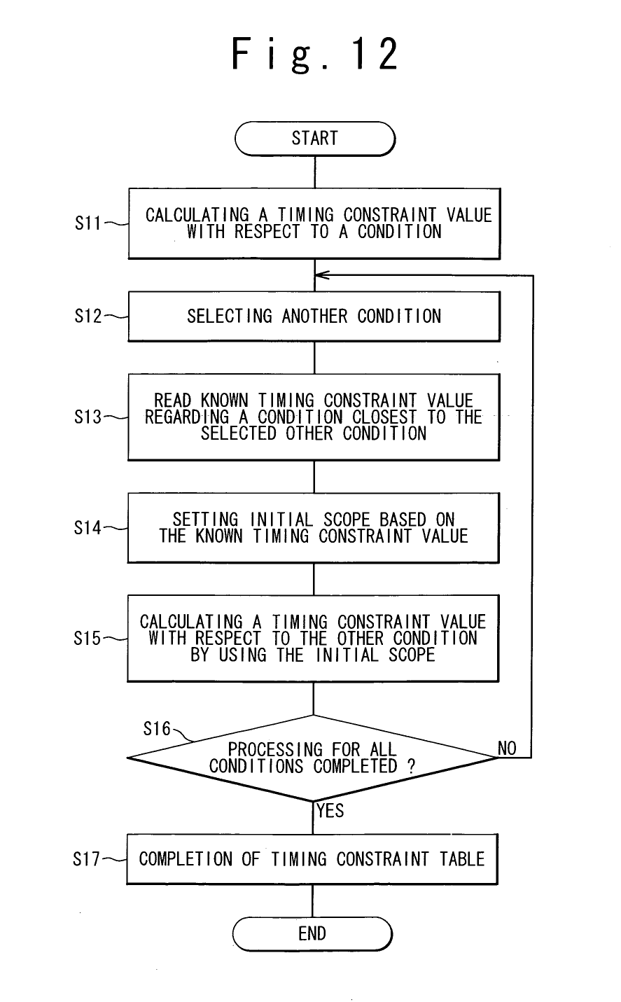

FIG. 12 is a flow chart which summarizes the method of creating the timing constraint library 10 according to the present embodiment. First, a timing constraint value with respect to a certain condition is calculated through the method as in the first embodiment (Step S11). Next, another condition is selected from the timing constraint table (see FIG. 4) (Step S12). Next, the “already-known timing constraint value” with respect to a closest condition to the selected other condition is read out from the timing constraint table (Step S13). Next, a new initial scope SC0 is set based on the already-known timing constraint value (Step S14). Next, a timing constraint value corresponding to the other condition is calculated by using the new initial scope SC0 (Step S15). When the processing is not completed for all the conditions (Step S16; No), the above-mentioned steps S12 to S15 are repeated. When the processing is completed for all the conditions (Step S16; Yes), the timing constraint table is completed (Step S17). According to the present embodiment, the time for creating the timing constraint library 10 is shortened because the number of simulation times is reduced.

### Third Embodiment

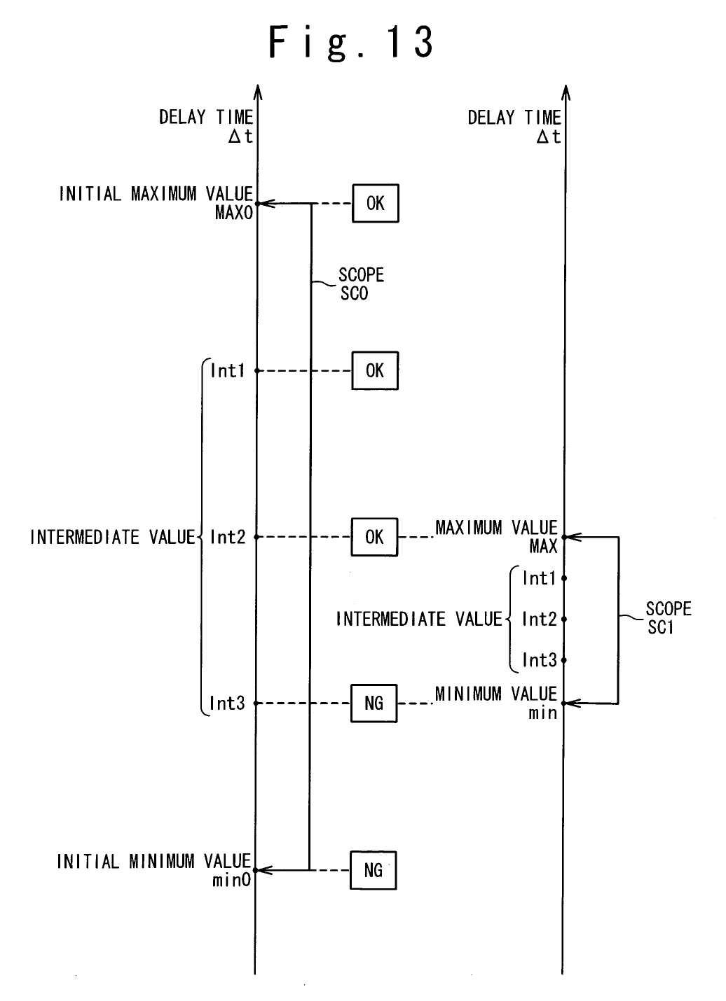

The algorithm used in searching for the solution from the scope SC is not limited to the above-mentioned “binary search method”. FIG. 13 is a conceptual diagram for explaining a method of searching for the solution (setup time) according to a third embodiment of the present invention. A longitudinal axis in the figure denotes a delay time Δt.

First, an initial maximum value MAX0 and an initial minimum value min0 are set appropriately, and an initial scope SC0 which is a range searched for the solution is determined. The initial scope SC0 includes the timing constraint value to be obtained. Next, n preliminary timing constraint values (n is an integer not less than 3) are selected from the initial scope SC0. The n preliminary timing constraint values include the initial maximum value MAX0, the initial minimum value min0 and (n-2) intermediate values Int. The initial scope SC0 is divided into (n-1) ranges equally by the n preliminary timing constraint values. An example when the n is set to 5 is shown in FIG. 13. It should be noted that the binary search method described in the first and the second embodiments corresponds to a special case where the n is set to 3.

Next, a simulation is performed based on each of the five preliminary setup times MAX0, min0 and Int1 to Int3 to verify whether the target cell operates normally or not. In the example shown in FIG. 13, the cell operates normally as a result of the simulation based on each of the initial maximum value MAX0, the intermediate values Int1 and Int2, while the cell does not operate normally as a result of the simulation based on each of the intermediate value Int3 and the initial minimum value min0. In this case, it is obvious that the solution to be obtained, namely, the boundary between the normal operation (OK) and the abnormal operation (NG) of the cell lies between the intermediate value Int2 and the intermediate value Int3. Therefore, two preliminary setup times Int2 and Int3, which are closest to the solution to be obtained, are selected and extracted from the five preliminary setup times MAX0, min0 and Int1 to Int3.

Next, a range defined by the two extracted preliminary setup times Int2 and Int3 is set as a new scope SC1. That is to say, the extracted preliminary setup time Int2 is set to the maximum value MAX of the new scope SC1, and the extracted preliminary setup time Int3 is set to the minimum value min of the new scope SC1. The size of the new scope SC1 is given as: “SC1=MAX−min”. Then, the above-mentioned processes are repeated with using the new scope SC1.

The above-mentioned operation is repeated until the size of the scope SC becomes equal to or lower than a predetermined criterion (grit number). When the size of the scope SC becomes equal to or less than the predetermined criterion, the timing constraint value is determined on the basis of the scope SC. In this manner, the timing constraint library 10 is created. Also in the present embodiment, the simulation precision is set based on the size of scope SC (MAX−min). More specifically, the simulation precision is set to be higher as the size of the scope SC becomes smaller.

A configuration and an operation of a system for realizing the method according to the present embodiment are similar to those of the timing constraint library creating system 100 shown in FIGS. 8 and 9. Also, a timing constraint value may be calculated based on another already-known timing constraint value, as in the second embodiment.

According to the system and method for creating the timing constraint library 10 of the present invention, as described above, calculation load in an initial stage of the simulation is reduced, and thus the time required for the simulation is shortened. That is to say, the time for creating the timing constraint library 10 is reduced. Moreover, as the whereabouts of the solution come to be narrowed down, the precision of simulation is set to be higher. Therefore, precision of the solution obtained as a result is ensured. In other words, precision of the created timing constraint library 10 is ensured.

It is apparent that the present invention is not limited to the above embodiment, and that may be modified and changed without departing from the scope and spirit of the invention.

What is claimed is:

1. A method of creating a timing constraint information which provides a timing constraint value of a cell, comprising:
(A) a processor setting a predetermined initial range including said timing constraint value as a scope;
(B) said processor selecting n (n is an integer not less than 3) preliminary timing constraint values from said scope;
(C) said processor executing a simulation by using each of said n preliminary timing constraint values to verify whether said cell operates normally or not;
(D) said processor extracting two preliminary timing constraint values from said n preliminary timing constraint values based on a result of said simulation, wherein said two preliminary timing constraint values are two closest values to a boundary between an normal operation and an abnormal operation of said cell;
(E) said processor setting a range defined by said two preliminary timing constraint values as said scope;
(F) said processor determining said timing constraint value by repeating said step (B) to said step (E) until a size of said scope becomes equal to or lower than a predetermined criterion; and
(G) said processor storing said determined timing constraint value in a memory device as said timing constraint information,
wherein in said step (C) said processor sets a precision of said simulation based on said size of scope.

2. The method according to claim 1,
wherein in said step (C) said processor sets said precision of simulation such that said precision of simulation becomes higher as said size of scope becomes smaller.

3. The method according to claim 2,
wherein said n is 3, and said n preliminary timing constraint values include a maximum value of said scope, a minimum value of said scope and an average value of said maximum value and said minimum value.

4. The method according to claim 2,
wherein said n preliminary timing constraint values include a maximum value of said scope, a minimum value of said scope and (n-2) values which divide said scope into (n-1) ranges equally.

5. The method according to claim 1,
wherein said memory device stores a precision decision table which indicates a relation between said size of scope and said precision of simulation, and
said processor determines said precision of simulation by referring to said precision decision table.

6. The method according to claim 1,
wherein said timing constraint information includes a timing constraint table of said timing constraint value with respect to a plurality of conditions.

7. The method according to claim 6, further comprising:
(H) said processor setting a range smaller than said predetermined initial range as a new initial range,
wherein said new initial range includes a first timing constraint value which is said determined timing constraint value stored in said memory device, and said first timing constraint value is associated with a first condition of said plurality of conditions; and
(I) said processor executing said step (A) to said step (G) by using said new initial range set in said step (H), when determining a second timing constraint value associated with a second condition of said plurality of conditions other than said first condition.

8. The method according to claim 7,
wherein said second condition is closest to said first condition among said plurality of conditions.

9. The method according to claim 7,
wherein said processor sets said new initial range to a range whose center value is said first timing constraint value.

10. The method according to claim 8,
wherein said processor sets said new initial range to a range whose center value is said first timing constraint value.

11. The method according to claim 2,
wherein said timing constraint information includes a timing constraint table of said timing constraint value with respect to a plurality of conditions,
said method further comprises:
(H) said processor setting a range smaller than said predetermined initial range as a new initial range,
wherein said new initial range includes a first timing constraint value which is said determined timing constraint value stored in said memory device, and said first timing constraint value is associated with a first condition of said plurality of conditions; and
(I) said processor executing said step (A) to said step (G) by using said new initial range set in said step (H), when determining a second timing constraint value associated with a second condition of said plurality of conditions other than said first condition.

12. The method according to claim 11,
wherein said second condition is closest to said first condition among said plurality of conditions.

13. The method according to claim 4,
wherein said timing constraint information includes a timing constraint table of said timing constraint value with respect to a plurality of conditions,
said method further comprises:
(H) said processor setting a range smaller than said predetermined initial range as a new initial range,
wherein said new initial range includes a first timing constraint value which is said determined timing constraint value stored in said memory device, and said first timing constraint value is associated with a first condition of said plurality of conditions; and
(I) said processor executing said step (A) to said step (G) by using said new initial range set in said step (H), when determining a second timing constraint value associated with a second condition of said plurality of conditions other than said first condition.

14. The method according to claim 13,
wherein said second condition is closest to said first condition among said plurality of conditions.

15. A method of creating a timing constraint information which provides a timing constraint value of a cell, comprising:
(a) a processor setting a predetermined range including said timing constraint value as a scope;
(b) said processor executing a simulation by using a preliminary timing constraint value within said scope to verify whether said cell operates normally or not;
(c) said processor determining said timing constraint value by repeating said step
(b) based on a binary search method; and
(d) said processor storing said determined timing constraint value in a memory device as said timing constraint information,
wherein in said step (b) said processor sets a precision of said simulation based on a size of said scope.

16. The method according to claim 15,
wherein in said step (b) said processor sets said precision of simulation such that said precision of simulation becomes higher as said size of scope becomes smaller.

17. A system for creating a timing constraint information which provides a timing constraint value of a cell, comprising:
a library creating module which is realized by a processor and a library creating software executed by said processor; and
a simulation module configured to carry out a simulation to verify whether said cell operates normally or not under a predetermined condition, which is realized by said processor and a simulation software executed by said processor,
wherein said library creating module sets a predetermined initial range including said timing constraint value as a scope,
said library creating module carries out a first operation of selecting n (n is an integer not less than 3) preliminary timing constraint values from said scope and deciding a precision of said simulation based on a size of said scope,
said simulation module carries out said simulation by using each of said n preliminary timing constraint values based on said decided precision,
said library creating module carries out a second operation of extracting two preliminary timing constraint values closest to a boundary between an normal operation and an abnormal operation of said cell from said n preliminary timing constraint values based on a result of said simulation, and setting a range defined by said two preliminary timing constraint values as said scope,
said library creating module and said simulation module carry out respective of said first operation, said second operation and said simulation repeatedly,
said library creating module determines said timing constraint value based on said scope when said size of scope becomes equal to or lower than a predetermined criterion, and
said library creating module stores said determined timing constraint value in a memory device as said timing constraint information.

18. The system according to claim 17,
wherein said library creating module sets said precision of simulation such that said precision of simulation becomes higher as said size of scope becomes smaller.

19. The system according to claim 18,
wherein said n preliminary timing constraint values include a maximum value of said scope, a minimum value of said scope and (n-2) values which divide said scope into (n-1) ranges equally.

20. The system according to claim 17,
wherein said memory device stores a precision decision table which indicates a relation between said size of scope and said precision of simulation, and
said library creating module determines said precision of simulation by referring to said precision decision table.
